(19) United States
(12) Patent Application Publication
(10) Pub. No.: US 2026/0188024 A1
(43) Pub. Date: Jul. 2, 2026

(54) SYSTEM AND METHOD OF OPERATING SYSTEM

(71) Applicant: TOYOTA JIDOSHA KABUSHIKI KAISHA, Toyota-shi (JP)

(72) Inventors: Masato ENDO, Nagoya-shi (JP); Shuhei MANABE, Toyota-shi (JP)

(73) Assignee: TOYOTA JIDOSHA KABUSHIKI KAISHA, Toyota-shi (JP)

(21) Appl. No.: 19/430,042

(22) Filed: Dec. 22, 2025

(30) Foreign Application Priority Data
Dec. 26, 2024 (JP) 2024-231247

(51) Int. Cl. G06V 20/59; G06V 20/40

(52) U.S. Cl. CPC G06V 20/597; G06V 20/41

(57) ABSTRACT

A system includes in-vehicle apparatuses that acquire information on operation features of multiple respective drivers with different driving characteristics, and a server apparatus that communicates with the in-vehicle apparatuses. The server apparatus executes a process to derive a criterion for classifying the operation features into multiple categories according to the driving characteristics using the information on the operation features, and transmits, to each of the in-vehicle apparatuses, information to construct a model that classifies an operation feature into a category based on the criterion, on the condition that the criterion corresponds to a predetermined degree of convergence. Each of the in-vehicle apparatuses classifies a driver's operation feature into a category using the model.

### CROSS-REFERENCE TO RELATED APPLICATION

This application claims priority to Japanese Patent Application No. 2024-231247, filed on December 26, 2024, the entire contents of which are incorporated herein by reference.

### TECHNICAL FIELD

The present disclosure relates to a system and a method of operating the system.

### BACKGROUND

Technology for diagnosing the state of a mobile object including a vehicle, based on the behavior of the mobile object is known. For example, Patent Literatures (PTLs) 1 to 3 disclose systems that diagnose a vehicle or the like by processing, on a cloud server, information obtained by detecting the behavior of the vehicle or the like.

### CITATION LIST

### Patent Literature

PTL 1: JP 2017-013742 A

PTL 2: JP 2019-131187 A

PTL 3: JP 2021-196678 A

### SUMMARY

There is room for improvement in the accuracy of various diagnoses of vehicle driving using machine learning or the like.

A system and the like that enable improvement in the accuracy of diagnoses of vehicle driving will be disclosed below.

A system according to the present disclosure is a system including:

in-vehicle apparatuses configured to acquire information on operation features of multiple respective drivers with different driving characteristics; and

a server apparatus configured to communicate with the in-vehicle apparatuses,

wherein the server apparatus is configured to execute a process to derive a criterion for classifying the operation features into multiple categories according to the driving characteristics using the information on the operation features, and transmit, to each of the in-vehicle apparatuses, information to construct a model that classifies an operation feature into a category based on the criterion, on the condition that the criterion corresponds to a predetermined degree of convergence, and

each of the in-vehicle apparatuses is configured to classify a driver's operation feature into a category using the model.

A method of operating a system according to another aspect of the present disclosure is a method of operating a system including in-vehicle apparatuses configured to acquire information on operation features of multiple respective drivers with different driving characteristics, and a server apparatus configured to communicate with the in-vehicle apparatuses, the method including:

executing, by the server apparatus, a process to derive a criterion for classifying the operation features into multiple categories according to the driving characteristics using the information on the operation features, and transmitting, to each of the in-vehicle apparatuses, information to construct a model that classifies an operation feature into a category based on the criterion, on the condition that the criterion corresponds to a predetermined degree of convergence; and

classifying, by each of the in-vehicle apparatuses, a driver's operation feature into a category using the model.

The system and the like according to the present disclosure make it possible to improve the accuracy of diagnoses of vehicle driving.

### BRIEF DESCRIPTION OF THE DRAWINGS

In the accompanying drawings:

FIG. 1 is a diagram illustrating an example of a configuration of an information processing system;

FIG. 2 is a sequence diagram illustrating an example of operations of the information processing system; and

FIG. 3 is a flowchart illustrating an example of operations of a server apparatus.

### DETAILED DESCRIPTION

An embodiment will be described below.

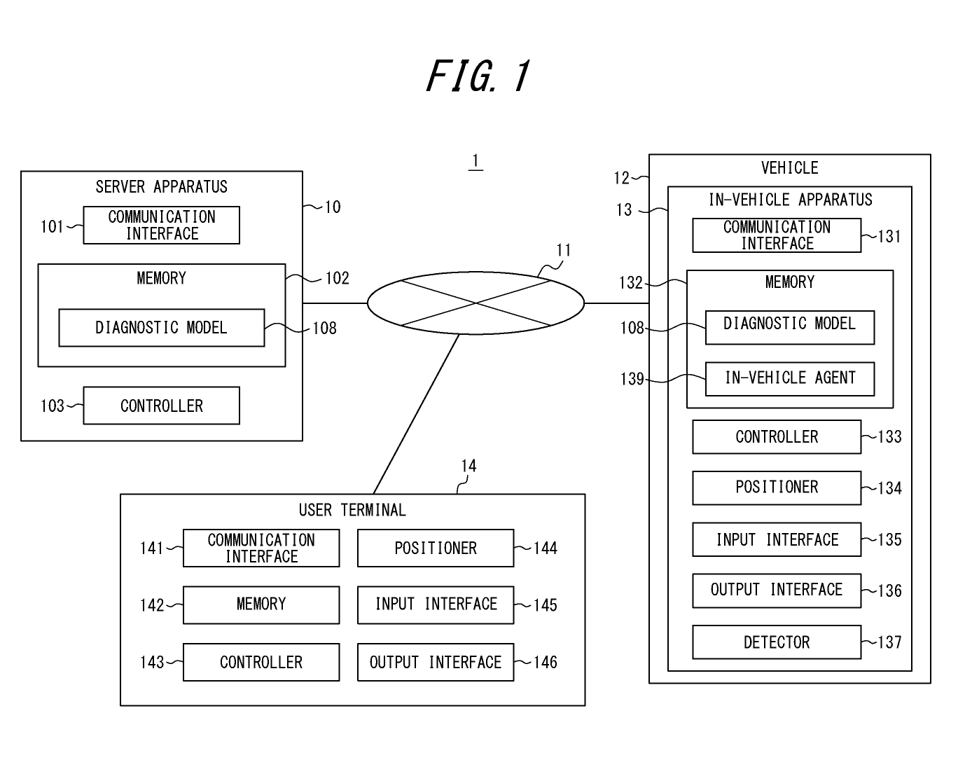

FIG. 1 is a diagram illustrating an example of a configuration of an information processing system according to the embodiment. An information processing system 1 includes at least one server apparatus 10, multiple in-vehicle apparatuses 13, and at least one user terminal 14 that are communicably connected to each other via a network 11. The server apparatus 10 is, for example, a server computer that belongs to a cloud computing system or another computing system, and functions as a server that implements various functions. The in-vehicle apparatuses 13 are, for example, navigation systems or the like that have communication functions and information processing functions, and are mounted in multiple respective vehicles 12. The vehicles 12 are vehicles such as passenger cars or commercial vehicles, and part or all of the driving is performed manually by drivers. The vehicles 12 are any type of automobiles such as gasoline vehicles, Battery Electric Vehicles (BEVs), Hybrid Electric Vehicles (HEVs), Plug-in Hybrid Electric Vehicle (PHEVs), or Fuel Cell Electric Vehicles (FCEVs). The user terminal 14 is an information processing terminal used by an operator of the information processing system 1 and is, for example, a personal computer (PC), a tablet terminal, a smartphone, or the like. The network 11 is the Internet, for example, but may also be an ad-hoc network, a LAN, a Metropolitan Area Network (MAN), other networks, or a combination of two or more thereof.

In the present embodiment, the information processing system 1 has the in-vehicle apparatuses 13 that acquire information on operation features of multiple respective drivers with different driving characteristics, and the server apparatus 10 that communicates with the in-vehicle apparatuses 13. The server apparatus 10 executes an optimization process to derive a criterion (hereinafter referred to as a classification criterion) for classifying the operation features into multiple categories (hereinafter referred to as characteristic categories) according to the driving characteristics using the operation features of the multiple respective drivers, and transmits, to each of the in-vehicle apparatuses 13, information to construct a model (hereinafter referred to as a diagnostic model) 108 that classifies an operation feature into a characteristic category based on the classification criterion, on the condition that the classification criterion corresponds to a predetermined degree of convergence. Here, the characteristic categories are categories corresponding to the driving characteristics of the drivers, and categories according to, for example, the presence or absence of a dangerous driving tendency or the number of accidents. The operation features are, for example, the control amounts of acceleration, braking, and the like and the motion state, such as speed and acceleration, of the vehicle 12. The classification criterion includes a type of operation features (hereinafter referred to as operation features of interest) that can be classified into the corresponding drivers' characteristic categories, and a threshold for classification in the operation features of interest. Each in-vehicle apparatus 13 classifies a driver's operation feature of interest into a characteristic category using the diagnostic model 108. Then, the in-vehicle apparatus 13 transmits information on the operation feature of interest to be newly diagnosed using the diagnostic model 108, to the server apparatus 10. As described above, the server apparatus 10 executes the optimization process of the diagnostic model 108, and after the correspondence between the operation features and the characteristic categories converges at a predetermined degree, that is, after the reliability of the classification criterion increases to a certain extent, the diagnostic model 108 is transferred to the in-vehicle apparatuses 13. Therefore, the in-vehicle apparatuses 13 can perform more accurate diagnoses using the diagnostic model 108. Since the in-vehicle apparatuses 13 transmit information on the operation features of interest, which are set as the classification criterion, to the server apparatus 10, the server apparatus 10 can perform the optimization process using information further conforming to the classification criterion, based on the information transmitted from the in-vehicle apparatuses 13. Thus, the reliability of the diagnostic model 108 is further improved. Therefore, it becomes possible to improve the accuracy of diagnoses regarding the driving of the vehicle 12.

Next, an example of a configuration of the server apparatus 10 will be described.

The server apparatus 10 includes a communication interface 101, a memory 102, and a controller 103. The server apparatus 10 may be a single computer or may be two or more computers that are communicably connected to each other and operate in cooperation. When the server apparatus 10 is configured with two or more computers, the configuration illustrated in FIG. 1 is arranged as appropriate on the two or more computers.

The communication interface 101 includes one or more interfaces for communication. The interfaces for communication include, for example, a LAN interface. The communication interface 101 receives information to be used for operations of the controller 103, and transmits information obtained by operations of the controller 103. The server apparatus 10 is connected to the network 11 by the communication interface 101, and communicates information with the in-vehicle apparatuses 13 and the user terminal 14 via the network 11.

The memory 102 includes, for example, one or more semiconductor memories, one or more magnetic memories, one or more optical memories, or a combination of at least two of these types, to function as a main memory, an auxiliary memory, or a cache memory. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 102 stores information to be used for operations of the controller 103 and information obtained by operations of the controller 103.

The controller 103 includes one or more processors, one or more dedicated circuits, or a combination thereof. The processors are general purpose processors, such as central processing units (CPUs), or dedicated processors, such as graphics processing units (GPUs), dedicated to specific processing. The dedicated circuits are, for example, field-programmable gate arrays (FPGAs), application specific integrated circuits (ASICs), or the like. The controller 103 executes information processing related to operations of the server apparatus 10 while controlling components of the server apparatus 10.

The functions of the server apparatus 10 are realized by execution of a control program by a processor included in the controller 103. The control program is a program for causing a computer to execute processing of steps included in the operations of the server apparatus 10, thereby enabling the computer to realize functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10, and be read from the medium by the server apparatus 10.

In the present embodiment, the memory 102 stores the diagnostic model 108. The diagnostic model 108 is an artificial intelligence (AI) model that is optimized to derive a classification criterion for classifying, using operation features of multiple respective drivers acquired from the in-vehicle apparatuses 13, the operation features into multiple characteristic categories according to driving characteristics, that is, operation features of interest and a threshold thereof.

Next, an example of a configuration of each in-vehicle apparatus 13 will be described.

The in-vehicle apparatus 13 includes a communication interface 131, a memory 132, a controller 133, a positioner 134, an input interface 135, an output interface 136, and a detector 137. These components may be configured as a single control apparatus, as two or more control apparatuses, or with another apparatus such as a control apparatus and a communication device. The control apparatus includes, for example, an electronic control unit (ECU) or the like. The communication device includes, for example, a data communication module (DCM) or the like. The components are communicably connected to each other or to equipment in the vehicle 12, through an in-vehicle network compliant with a standard such as a controller area network (CAN). The in-vehicle apparatus 13 may be configured to include, in part, a device equivalent to the user terminal 14.

The communication interface 131 includes a communication module compliant with a wired or wireless LAN standard, a module compliant with a mobile communication standard such as long term evolution (LTE), 4th generation (4G), or 5th generation (5G), or the like. The in-vehicle apparatus 13 connects to the network 11 via a nearby router apparatus or a mobile communication base station using the communication interface 131, and communicates information with other apparatuses over the network 11.

The memory 132 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 132 functions as, for example, a main memory, an auxiliary memory, or a cache memory. The memory 132 stores information to be used for operations of the controller 133 and information obtained by operations of the controller 133.

The controller 133 includes one or more processors, one or more dedicated circuits, or a combination thereof. The processor is a general purpose processor such as a CPU, or a dedicated processor such as a GPU that is specialized for specific processing. The dedicated circuits are, for example, FPGAs or ASICs. The controller 133 executes information processing related to operations of the in-vehicle apparatus 13 while controlling components of the in-vehicle apparatus 13.

The functions of the controller 133 are realized by execution of a control/processing program by a processor included in the controller 133. The control/processing program is a program for causing a computer to execute processing of steps included in operations of the controller 133, thereby enabling the computer to realize the functions corresponding to the processing of the steps. That is, the control/processing program is a program for causing a computer to function as the controller 133. Some or all of the functions of the controller 133 may be realized by a dedicated circuit included in the controller 133.

The positioner 134 includes one or more global navigation satellite system (GNSS) receivers. The GNSS includes, for example, Global Positioning System (GPS), Quasi-Zenith Satellite System (QZSS), BeiDou, Global Navigation Satellite System (GLONASS), and/or Galileo. The positioner 134 transmits a positioning result to the controller 133, and the controller 133 calculates positional information on the in-vehicle apparatus 13, that is, the vehicle 12.

The input interface 135 includes one or more interfaces for input. The interfaces for input include, for example, a microphone that accepts voice input, physical keys, capacitive keys, a pointing device, a touch screen integrally provided with a display, or the like. The interfaces for input include an interface with a camera that is provided in the vehicle 12 to capture images of the interior or exterior of the vehicle 12. The camera may be built into the in-vehicle apparatus 13 or may be separate. The input interface 135 accepts input operations of information to be used for operations of the controller 133 by a user such as a driver, voice, or captured images of the driver or the like by a camera, and transmits the accepted information to the controller 133.

The output interface 136 includes one or more interfaces for output. The interfaces for output include, for example, a speaker that outputs sound, a display that outputs images, and the like. The display is, for example, a liquid crystal display (LCD) or an organic electro-luminescent (EL) display. The output interface 136 outputs information to be obtained by operations of the controller 133.

The detector 137 has sensors that detect various events occurring in the vehicle 12, or interfaces with such sensors. The sensors include, for example, sensors that detect the speed, acceleration in longitudinal and lateral directions, deceleration, accelerator operation amount, brake operation amount, steering angle, turn signal lighting time, fuel consumption per unit time, eco mode selection state, odometer value, safety equipment operation information, remaining amounts of engine oil and the like, degree of wear of brake pads, degree of battery degradation, and the like of the vehicle 12. The sensors include radar using millimeter waves, infrared rays, or the like that detects objects around the vehicle 12. The detector 137 transmits vehicle information indicating various states of the vehicle 12 detected by the sensors to the controller 133.

The controller 133 controls each of the communication interface 131, the memory 132, the positioner 134, the input interface 135, the output interface 136, and the detector 137 while exchanging various information with these components, and also controls operations of the vehicle 12. When the vehicle 12 travels, the controller 133 presents various information such as route information necessary for driving to the driver via the output interface 136 to provide a navigation function, and controls partial automated driving of the vehicle 12.

In the present embodiment, the memory 132 stores the diagnostic model 108 and an in-vehicle agent 139. The diagnostic model 108 is stored in the in-vehicle apparatus 13 by being transferred from the server apparatus 10. The controller 133 executes the diagnostic model 108, which has learned by machine learning at the server apparatus 10, to perform a diagnosis based on an operation feature of the vehicle 12. The in-vehicle agent 139 is a dialogue AI module that generates a notification of the diagnostic result from the diagnostic model 138 to the driver, and has a natural language processing function, a knowledge base regarding diagnostic results and the driver's preferences, and the like.

Next, an example of a configuration of the user terminal 14 will be described.

The user terminal 14 includes a communication interface 141, a memory 142, a controller 143, a positioner 144, an input interface 145, and an output interface 146.

The communication interface 141 includes a communication module compliant with a wired or wireless LAN standard, a module compliant with a mobile communication standard such as LTE, 4G, or 5G, or the like. The user terminal 14 connects to the network 11 via a nearby router apparatus or mobile communication base station using the communication interface 141, and communicates information with other apparatuses over the network 11.

The memory 142 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 142 functions as, for example, a main memory, an auxiliary memory, or a cache memory. The memory 142 stores information to be used for operations of the controller 143 and information obtained by operations of the controller 143.

The controller 143 includes one or more processors, one or more dedicated circuits, or a combination thereof. The processors are general purpose processors such as CPUs, or dedicated processors such as GPUs that are specialized for specific processing. The dedicated circuits are, for example, FPGAs or ASICs. The controller 143 executes information processing related to operations of the user terminal 14 while controlling components of the user terminal 14.

The positioner 144 includes one or more GNSS receivers. GNSS includes, for example, GPS, QZSS, BeiDou, GLONASS, and/or Galileo. The positioner 144 transmits a positioning result to the controller 143, and the controller 143 calculates positional information on the user terminal 14.

The input interface 145 includes one or more interfaces for input. The interfaces for input include, for example, a microphone that accepts voice input, physical keys, capacitive keys, a pointing device, a touch screen integrally provided with a display, a camera that captures images, or the like. The input interface 145 accepts operations for inputting information to be used for operations of the controller 143 and transmits the input information to the controller 143.

The output interface 146 includes one or more interfaces for output. The interfaces for output include, for example, a speaker, a display, or the like. The display is, for example, an LCD or an organic EL display. The output interface 146 outputs information obtained by operations of the controller 143.

The functions of the controller 143 are realized by execution of a control/processing program by a processor included in the controller 143. The control/processing program is a program for causing a computer to execute processing of steps included in operations of the controller 143, thereby enabling the computer to realize the functions corresponding to the processing of the steps. That is, the control/processing program is a program for causing a computer to function as the controller 143. Some or all of the functions of the controller 143 may be realized by a dedicated circuit included in the controller 143.

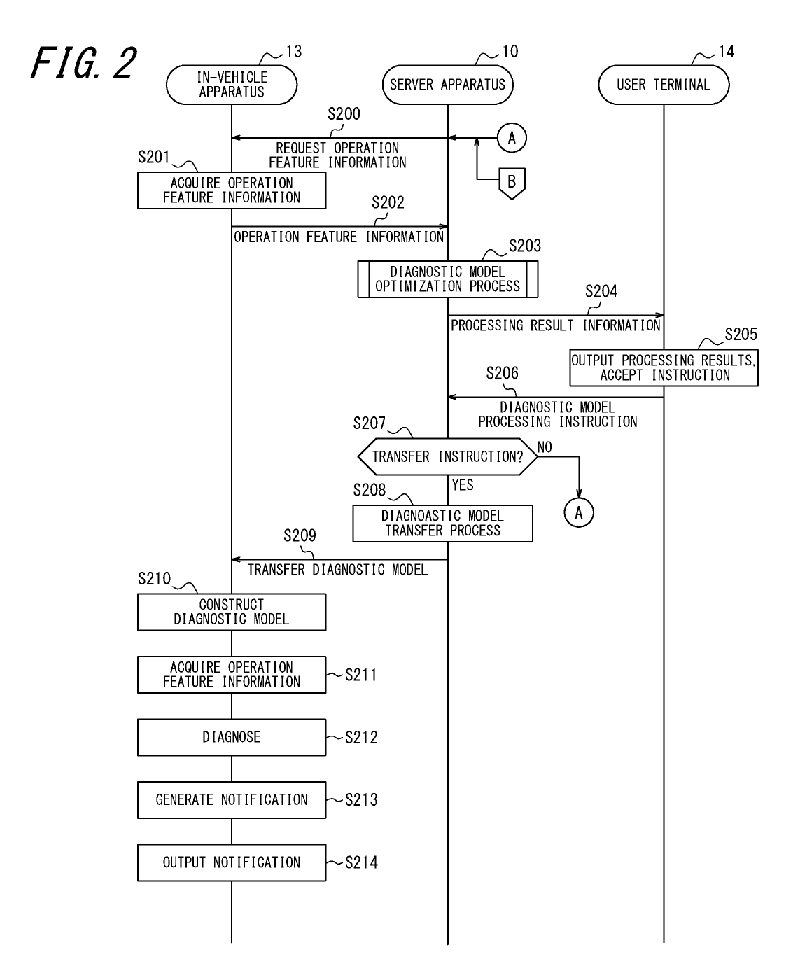

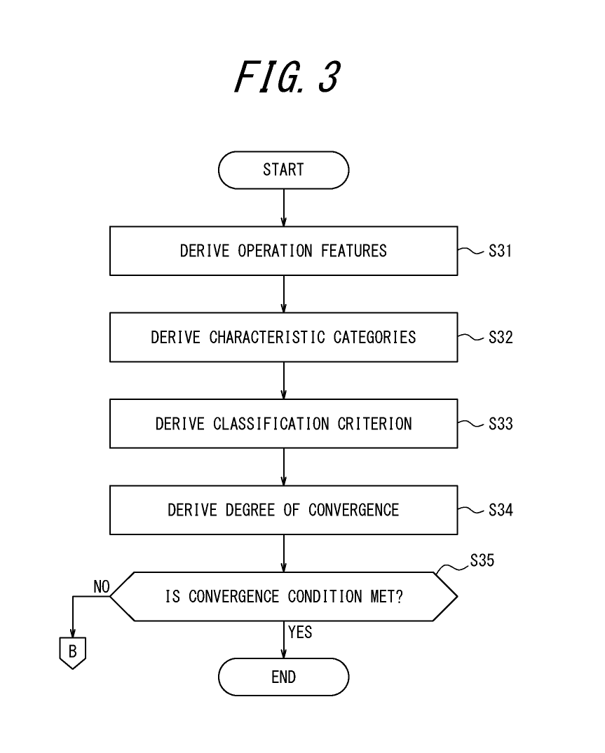

Next, operations of the information processing system 1 will be described with reference to FIG. 2 and FIG. 3.

FIG. 2 is a sequence diagram illustrating an operation procedure of the information processing system 1 according to the present embodiment. FIG. 2 illustrates a procedure in coordinated operations of the multiple in-vehicle apparatuses 13 and the user terminal 14. The steps pertaining to the various information processing by the server apparatus 10, each in-vehicle apparatus 13, and the user terminal 14 in FIG. 2 are performed by the respective controllers 103, 133, and 143. The steps pertaining to transmitting and receiving various information to and from the server apparatus 10, each in-vehicle apparatus 13, and the user terminal 14 are performed by the respective controllers 103, 133, and 143 transmitting and receiving information to and from each other via the respective communication interfaces 101, 131, and 141. In the server apparatus 10, each in-vehicle apparatus 13, and the user terminal 14, the respective controllers 103, 133, and 143 appropriately store information to be transmitted, received, or processed, in the respective memories 102, 132, and 142. Furthermore, in each in-vehicle apparatus 13 and the user terminal 14, the controllers 133 and 143 accept input of various information by the respective input interfaces 135 and 145, and output various information by the respective output interfaces 136 and 146.

In step S200, the server apparatus 10 requests operation feature information from the multiple in-vehicle apparatuses 13. Step S200 is executed, for example, at any cycle of several days to several weeks, or as needed according to an operator's instruction. The operator can operate the user terminal 14 to instruct the server apparatus 10 to request operation feature information. For example, the server apparatus 10 stores identification information on the multiple communicable in-vehicle apparatuses 13 in the memory 102 and transmits requests for operation feature information to each in-vehicle apparatus 13 using the identification information. The identification information for each in-vehicle apparatus 13 includes identification information on a driver who drives the vehicle 12 using the in-vehicle apparatus 13.

In step S201, each in-vehicle apparatus 13 acquires operation feature information. The controller 133 acquires target information including the control amounts of the brake, accelerator, steering, turn signals, and the like by the driver, and the motion state such as moving speed, acceleration in travel and lateral directions, and distance to other vehicles of the vehicle 12 through various sensors and input interfaces provided in the vehicle 12. Each piece of information may be timestamped at the time of acquisition.

In step S202, each in-vehicle apparatus 13 transmits the operation feature information to the server apparatus 10.

In step S203, the server apparatus 10 performs an optimization process of the diagnostic model 108 using the operation feature information transmitted from the in-vehicle apparatuses 13. A detailed procedure of step S203 is illustrated in FIG. 3.

FIG. 3 is a flowchart illustrating an example procedure of the optimization process of the diagnostic model 108 in the server apparatus 10. Each step in FIG. 3 is a step of information processing executed by the controller 103.

In S31, the controller 103 derives operation features for each driving scene. The controller 103 calculates the amounts of change in the speed, acceleration in longitudinal and lateral directions, deceleration, accelerator operation amount, brake operation amount, steering angle, and the like per unit time, or turn signal lighting time, and derives, for example, driving scenes of rapid acceleration, hard braking, sharp steering, and the like. The controller 103 then derives operation features for each scene, such as the accelerator operation amount and acceleration of the vehicle 12 during rapid acceleration, the brake operation amount and acceleration of the vehicle 12 during hard braking, the steering angle, turn signal lighting time, and lateral acceleration of the vehicle 12 during sharp steering.

In S32, the controller 103 derives characteristic categories. The characteristic categories are categories regarding the drivers using the in-vehicle apparatuses 13, such as the presence or absence of a tendency for dangerous driving or the number of accidents is high or low. The controller 103 acquires accident history information for each driver using the driver's identification information from another server that has the drivers' accident history information. The controller 103 then determines whether the number of accidents for each driver over a certain period, such as the past one to several years, is high or low based on a certain criterion, such as the average or median of the total number of accidents, to derive the characteristic categories. The controller 103 then stores information in which the operation features of each driver for each vehicle 12 are associated with a derived characteristic category.

In S33, the controller 103 derives a classification criterion. Specifically, the controller 103 derives, from the multiple types of operation features, a type of operation features of interest that can be classified into the corresponding drivers' characteristic categories, and a threshold for classification in the operation features of interest. The controller 103 determines the operation features of interest using a machine learning method such as clustering or decision trees, an analysis method such as filtering or a dimensionality reduction, or the like from among, for example, the accelerator operation amount and acceleration of the vehicle 12 during rapid acceleration, the brake operation amount and acceleration of the vehicle 12 during hard braking, the steering angle, turn signal lighting time, and lateral acceleration of the vehicle 12 during sharp steering. The controller 103 then derives a threshold for classifying the operation features of interest into the corresponding drivers' characteristic categories, such as a category with a high number of accidents or a category with a low number of accidents. For example, when the operation features of interest are the brake operation amounts per unit time, a threshold is derived so that the brake operation amounts of drivers belonging to the characteristic category with a high number of accidents are classified into the characteristic category with a high number of accidents, and the brake operation amounts of drivers belonging to the characteristic category with a low number of accidents are classified into the characteristic category with a low number of accidents. When the operation features of interest are the turn signal lighting time, a threshold is derived so that the turn signal lighting time of drivers belonging to the characteristic category with a high number of accidents is classified into the characteristic category with a high number of accidents, and the turn signal lighting time of drivers belonging to the characteristic category with a low number of accidents is classified into the characteristic category with a low number of accidents.

In S34, the controller 103 derives the degree of convergence. The degree of convergence is, for example, the degree of agreement between the result of classifying the operation features into the characteristic categories based on the classification criterion derived in the current optimization process cycle and the characteristic categories of the drivers associated with the operation features. The degree of convergence is, for example, the difference between the degree of agreement in a past optimization process cycle and the degree of agreement in the current optimization process cycle. Alternatively, the degree of convergence may be the number of executions of optimization process cycles.

In S35, the controller 103 determines whether the degree of convergence corresponds to a convergence condition. The convergence condition is, for example, a condition of the value of the degree of agreement (for example, 0.8 or higher), a condition of the difference in the degree of agreement (for example, 0.05 or less), a condition of the number of optimization process cycles (for example, 5 times or more), or the like. When the degree of convergence corresponds to the convergence condition (Yes in step S35), the controller 103 ends the procedure in FIG. 3. When the degree of convergence does not correspond to the convergence condition (No in step S35), the controller 103 returns to step S200 in FIG. 2. Note that, in a case in which a past degree of agreement is referenced as a criterion, there is no past degree of agreement in a first machine learning cycle of the diagnostic model, so the controller 103 can determine that the degree of convergence does not correspond to the convergence condition. When returning to step S200 in FIG. 2, the controller 103 requests operation feature information (step S200), acquires operation feature information (step S202), and executes the optimization process of the diagnostic model (S203) again. Therefore, steps S200 to S203 are repeatedly executed until the degree of convergence meets the convergence condition.

Returning to FIG. 2, in S204, the server apparatus 10 transmits optimization processing result information to the user terminal 14. The optimization processing result information includes information for visualizing the type of operation features of interest, threshold, classification result, degree of convergence, and the like.

In S205, the user terminal 14 outputs the processing results and accepts an instruction from the operator. The learning results are presented to the operator, for example, displayed on a screen or output as sound. The operator can check the processing results and appropriately determine whether to transfer the diagnostic model 108 to the in-vehicle apparatuses 13. Then, the operator inputs a processing instruction for the diagnostic model 108 by operating a touch panel, keyboard, or the like. The processing instruction is an instruction to transfer the diagnostic model 108 to the in-vehicle apparatuses 13, or an instruction to continue the optimization process of the diagnostic model 108.

In S206, the user terminal 14 transmits the diagnostic model processing instruction to the server apparatus 10.

In S207, when the diagnostic model processing instruction is an instruction to transfer the diagnostic model 108 to the in-vehicle apparatuses 13 (Yes in S207), the server apparatus 10 proceeds to step S208. When the diagnostic model processing instruction is an instruction to continue the machine learning of the diagnostic model 108 (No in S207), the server apparatus 10 returns to step S200 and executes steps S200 to S206 again.

In S208, the server apparatus 10 executes a process to transfer the diagnostic model 108 to the in-vehicle apparatuses 13. The server apparatus 10 generates information for configuring the diagnostic model 108, such as source code, configuration files, and reference datasets, in a transferable format.

In S209, the server apparatus 10 transfers the diagnostic model 108 to the in-vehicle apparatuses 13. The server apparatus 10 transmits the information for configuring the diagnostic model 108 to the in-vehicle apparatuses 13.

In S210, each in-vehicle apparatus 13 constructs the diagnostic model 108. Each in-vehicle apparatus 13 acquires and installs an application program to implement the diagnostic model 108 from a server of a provider and sets various information to be transmitted from the server apparatus 10. In the optimization process of the diagnostic model 108 in the server apparatus 10, when the operation features of interest are newly set or changed, the acquisition frequency of those operation features of interest may be increased in the in-vehicle apparatus 13.

In S211, each in-vehicle apparatus 13 acquires operation feature information. The operation feature information may be acquired at any cycle, such as several tens of milliseconds to several seconds. The in-vehicle apparatus 13 may acquire an operation feature of interest at a higher frequency than other operation features.

In S212, each in-vehicle apparatus 13 performs a diagnosis using the diagnostic model 108. The controller 133 executes the diagnostic model 108 and performs a diagnosis using information on the operation feature of interest, in other words, classifies a driving operation corresponding to the operation feature of interest into a characteristic category. For example, when the operation feature of interest is the amount of brake operation per unit time, the controller 133 diagnoses the amount of brake operation that exceeds the threshold, that is, the amount of brake operation indicating hard braking as the characteristic category with a high number of accidents, and the amount of brake operation equal to or less than the threshold, that is, the amount of brake operation indicating gentle braking as the characteristic category with a low number of accidents. For example, when the operation feature of interest is the turn signal lighting time, the controller 103 diagnoses turn signal lighting time shorter than the threshold, that is, turn signal lighting time indicating a sharp right or left turn as the characteristic category with a high number of accidents, and turn signal lighting time equal to or longer than the threshold, that is, turn signal lighting time indicating a right or left turn with sufficient lead time as the characteristic category with a low number of accidents.

In S213, the in-vehicle apparatus 13 generates a notification based on the diagnostic result. When the diagnostic result indicates a high number of accidents, the controller 133 generates, as a notification, a message of "Danger: Hard Braking!" or "Caution: Sharp Steering!" by the in-vehicle agent 139. Alternatively, the notification may be flashing of warning light or output of warning sound, in addition to or instead of the message.

In S214, the in-vehicle apparatus 13 outputs the notification to the driver. The message of the notification may be displayed on a display of the output interface 136 or output as sound through a speaker. Additionally, the warning light may flash or the warning sound may be output. Such notification output can contribute to deterring dangerous driving or the like by the driver. The in-vehicle apparatus 13 may output diagnostic results to the driver at the end of driving, rather than for each diagnosis, to encourage the driver to reflect on the trip. In that case, when the number of times diagnosed with a high number of accidents exceeds a certain criterion, the in-vehicle apparatus 13 can output a message such as "There is a tendency for many sudden brakes, so please be careful."

By the operation procedure as described above, the diagnostic model 109 optimized in the server apparatus 10 is transferred to the in-vehicle apparatuses 13, and each in-vehicle apparatus 13 performs a diagnosis based on an operation feature. Furthermore, for example, when information on newly set or changed operation features of interest is acquired at a higher frequency and transmitted to the server apparatus 10, the server apparatus 10 can perform optimization based on the information further conforming to the classification criterion. Thus, the reliability of the diagnostic model 108 is further improved. Therefore, it becomes possible to improve the accuracy of diagnoses regarding the driving of the vehicle 12.

In the above operation procedure, the optimization processing results may not be examined by the operator using the user terminal 14, in other words, steps S204 to S207 may be omitted. In that case, when the degree of convergence of the diagnostic model 108 meets the condition, the server apparatus 10 performs steps S208 and beyond and transfers the diagnostic model 108 to the in-vehicle apparatuses 13.

In the above embodiment, processing/control programs that specify the operations of the vehicles 12 and the user terminal 14 may be stored in the memory 102 of the server apparatus 10 or in the memory of another server apparatus and downloaded to each apparatus via the network 11, or may be stored on a non-transitory recording/storage medium readable by each apparatus and read by each apparatus from the medium.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

Examples of some embodiments of the present disclosure are described below. However, it should be noted that the embodiments of the present disclosure are not limited to these examples.

[Appendix 1] A system comprising:

in-vehicle apparatuses configured to acquire information on operation features of multiple respective drivers with different driving characteristics; and

a server apparatus configured to communicate with the in-vehicle apparatuses,

wherein the server apparatus is configured to execute a process to derive a criterion for classifying the operation features into multiple categories according to the driving characteristics using the information on the operation features, and transmit, to each of the in-vehicle apparatuses, information to construct a model that classifies an operation feature into a category based on the criterion, on condition that the criterion corresponds to a predetermined degree of convergence, and

each of the in-vehicle apparatuses is configured to classify a driver's operation feature into a category using the model.

[Appendix 2] The system according to appendix 1, wherein the predetermined degree of convergence is met when the categories of the operation features classified based on the criterion derived by the process and the driving characteristics corresponding to the operation features represent a predetermined degree of agreement.

[Appendix 3] The system according to appendix 1, wherein the predetermined degree of convergence is met when the process has been executed a predetermined number of times.

[Appendix 4] The system according to any one of appendices 1 to 3, wherein the criterion includes a first type of operation features for classification into the categories and a threshold in the first type of operation features.

[Appendix 5] The system according to appendix 4, wherein the server apparatus is configured to acquire the first type of operation features from the in-vehicle apparatuses when the in-vehicle apparatuses each use the model, and execute the process using the operation features including the first type of operation features.

[Appendix 6] The system according to any one of appendices 1 to 5, wherein the server apparatus is configured to transmit information on the criterion to a terminal apparatus, and transmit the model to each of the in-vehicle apparatuses on condition of receiving an instruction from the terminal apparatus.

[Appendix 7] A method of operating a system comprising in-vehicle apparatuses configured to acquire information on operation features of multiple respective drivers with different driving characteristics, and a server apparatus configured to communicate with the in-vehicle apparatuses, the method comprising:

executing, by the server apparatus, a process to derive a criterion for classifying the operation features into multiple categories according to the driving characteristics using the information on the operation features, and transmitting, to each of the in-vehicle apparatuses, information to construct a model that classifies an operation feature into a category based on the criterion, on condition that the criterion corresponds to a predetermined degree of convergence; and

classifying, by each of the in-vehicle apparatuses, a driver's operation feature into a category using the model.

[Appendix 8] The method according to appendix 7, wherein the predetermined degree of convergence is met when the categories of the operation features classified based on the criterion derived by the process and the driving characteristics corresponding to the operation features represent a predetermined degree of agreement.

[Appendix 9] The method according to appendix 7, wherein the predetermined degree of convergence is met when the process has been executed a predetermined number of times.

[Appendix 10] The method according to any one of appendices 7 to 9, wherein the criterion includes a first type of operation features for classification into the categories and a threshold in the first type of operation features.

[Appendix 11] The method according to appendix 10, wherein the server apparatus is configured to acquire the first type of operation features from the in-vehicle apparatuses when the in-vehicle apparatuses each use the model, and execute the process using the operation features including the first type of operation features.

[Appendix 12] The method according to any one of appendices 7 to 11, wherein the server apparatus is configured to transmit information on the criterion to a terminal apparatus, and transmit the model to each of the in-vehicle apparatuses on condition of receiving an instruction from the terminal apparatus.

1. A system comprising:
in-vehicle apparatuses; and
a server apparatus configured to communicate with the in-vehicle apparatuses,
wherein
the in-vehicle apparatuses have detectors configured to acquire information on operation features of multiple respective drivers with different driving characteristics,
the server apparatus is configured to acquire the information on the operation features from the in-vehicle apparatuses, acquire information on the driving characteristics from another server, derive a criterion for classifying the operation features into multiple categories according to the driving characteristics by artificial intelligence, and transmit, to each of the in-vehicle apparatuses, information to construct a model that classifies an operation feature into a category based on the criterion, on condition that the criterion corresponds to a predetermined degree of convergence, and
each of the in-vehicle apparatuses is configured to classify a driver's operation feature into a category using the model.

2. A system comprising:
in-vehicle apparatuses configured to acquire information on operation features of multiple respective drivers with different driving characteristics; and
a server apparatus configured to communicate with the in-vehicle apparatuses,
wherein
the server apparatus is configured to execute a process to derive a criterion for classifying the operation features into multiple categories according to the driving characteristics using the information on the operation features, and transmit, to each of the in-vehicle apparatuses, information to construct a model that classifies an operation feature into a category based on the criterion, on condition that the criterion corresponds to a predetermined degree of convergence, and
each of the in-vehicle apparatuses is configured to classify a driver's operation feature into a category using the model.

3. The system according to claim 2, wherein the predetermined degree of convergence is met when the categories of the operation features classified based on the criterion derived by the process and the driving characteristics corresponding to the operation features represent a predetermined degree of agreement.

4. The system according to claim 2, wherein the predetermined degree of convergence is met when the process has been executed a predetermined number of times.

5. The system according to claim 2, wherein the criterion includes a first type of operation features for classification into the categories and a threshold in the first type of operation features.

6. The system according to claim 5, wherein the server apparatus is configured to acquire the first type of operation features from the in-vehicle apparatuses when the in-vehicle apparatuses each use the model, and execute the process using the operation features including the first type of operation features.

7. The system according to claim 2, wherein the server apparatus is configured to transmit information on the criterion to a terminal apparatus, and transmit the model to each of the in-vehicle apparatuses on condition of receiving an instruction from the terminal apparatus.

8. A method of operating a system comprising in-vehicle apparatuses configured to acquire information on operation features of multiple respective drivers with different driving characteristics, and a server apparatus configured to communicate with the in-vehicle apparatuses, the method comprising:
executing, by the server apparatus, a process to derive a criterion for classifying the operation features into multiple categories according to the driving characteristics using the information on the operation features, and transmitting, to each of the in-vehicle apparatuses, information to construct a model that classifies an operation feature into a category based on the criterion, on condition that the criterion corresponds to a predetermined degree of convergence; and
classifying, by each of the in-vehicle apparatuses, a driver's operation feature into a category using the model.

9. The method according to claim 8, wherein the predetermined degree of convergence is met when the categories of the operation features classified based on the criterion derived by the process and the driving characteristics corresponding to the operation features represent a predetermined degree of agreement.

10. The method according to claim 8, wherein the predetermined degree of convergence is met when the process has been executed a predetermined number of times.

11. The method according to claim 8, wherein the criterion includes a first type of operation features for classification into the categories and a threshold in the first type of operation features.

12. The method according to claim 11, wherein the server apparatus is configured to acquire the first type of operation features from the in-vehicle apparatuses when the in-vehicle apparatuses each use the model, and execute the process using the operation features including the first type of operation features.

13. The method according to claim 8, wherein the server apparatus is configured to transmit information on the criterion to a terminal apparatus, and transmit the model to each of the in-vehicle apparatuses on condition of receiving an instruction from the terminal apparatus.
